(19) United States
(12) Patent Application Publication
(10) Pub. No.: US 2008/0116023 A1
(43) Pub. Date: May 22, 2008

(54) Disc Brake Pad Made of Multi-Compounds and Manufacturing Process Thereof

(76) Inventor: I-Ching Chen, Changhua (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/936,157

(22) Filed: Nov. 7, 2007

(30) Foreign Application Priority Data
Nov. 17, 2006 (TW) 095220218

(51) Int. Cl. F16D 69/02; B23P 19/04; B62L 1/00

(52) U.S. Cl. 188/251 A; 188/26; 29/700

(57) ABSTRACT

A disc brake pad made of multi-compounds and a manufacturing process thereof comprises a brake member compositely made of at least one frictional compound. In other words, the surface of the brake member is formed of more than two kinds of abrasion areas, for example, the surface of the brake member is made of for the frictional compound use in a wet condition and another frictional compound for use in a dry condition, such that the frictional compounds may be applied to the brake member solely or together so as to accommodate in different conditions.

### BACKGROUND OF THE INVENTION

1. Field of the Invention

The present invention relates to a disc brake pad, and more particularly to a disc brake pad made of multi-frictional compound and a manufacturing process thereof that may be used in different conditions.

2. Description of the Prior Arts

A prior art brake member of a disc brake pad is made of sole frictional compound, limiting its braking performance to certain conditions/environments. For instance, if the prior art brake member is made of sintered-metal compound, enhancing the brake effect at elevated temperatures and in the wet, but at the expense of increasing heat generation and excessive noise, wearing the brake disc, giving poor low temperature brake performance and transferring high levels of heat to the brake fluid limiting the effectiveness of the brake for prolonged braking. Nevertheless, if desiring to restrain the noises, wear, limit heat generation and improve low temperature performance by selection of an “organic” compound for example the high temperature performance of the brake member is accordingly diminished along with the pad wear rate and generally it's wet performance.

Conventionally, a large amount of organic compounds have been used to produce brake members, however as consequence of the high temperature resulting from friction when prolonged braking is required fade of the brake member will happen due to heat accumulation.

To overcome above-mentioned problem, an improved brake member may be manufactured by way of compounds with a higher metal material content. Unfortunately, as direct result of the frictional improvement, the pad will operate at a higher temperature and will more quickly conduct the heat to the piston, bringing about excessive heating of the brake oil impairing its ability function correctly and thereby limiting braking performance.

The present invention has arisen to mitigate and/or obviate the afore-described disadvantages.

### SUMMARY OF THE INVENTION

The primary object of the present invention is to provide a disc brake pad made of multi-compounds that is capable of giving an improved level of performance over a greater variety of environments and braking demand requirements when compared to a single compound pad, meaning it may be utilized in many different conditions.

The secondary object of the present invention is to provide a disc brake pad made of multi-compounds, the lest conductive one of which is applied on the opposite side of the section of backing plate that comes into direct contact with the piston over the piston, thereby limiting heat transfer to the braking fluid.

A third object of the present invention is to provide a disc brake pad made of multi-compounds that includes the heat resisting layer formed therein for lowering the heat conduction between the brake member and the piston.

A fourth object is to limit the contact area between the piston and brake backing plate further by reducing the heat transfer to the piston, furthermore protrusions on the backing plate surface will promote air flow between the backing plate and piston also allowing cooling of the piston/backing plate thus further limiting heat transfer.

Another object of the present invention is to provide a manufacturing process of a disc brake pad made of multi-compounds that may enhance the wear/life of both the pad itself and the brake disk.

In accordance with one aspect of the present invention, there is provided a disc brake pad made of multi-compounds and a manufacturing process thereof comprising a brake member compositely made of at least one abrasion area. In other words, the surface of the brake member is formed of more than two kinds of frictional materials, for example, the surface of the brake member is made of the frictional compound for use in a wet condition and another frictional compound for use in a dry condition, such that the abrasion area may be applied to the brake member solely or together so as to accommodate in different conditions.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the exploded components of a disc brake pad made of multi-compounds according to the present invention;

FIG. 2 is a perspective diagram illustrating the exploded components of the brake member of the disc brake pad made of multi-compounds according to a first embodiment of the present invention;

FIG. 3 is a perspective diagram illustrating the assembly of the brake member of the disc brake pad made of multi-compounds according to a first embodiment of the present invention;

FIG. 4 is a cross sectional diagram illustrating the operating state of the disc brake pad made of multi-compounds according to the present invention;

FIG. 5 is another cross sectional diagram illustrating the operating state of the disc brake pad made of multi-compounds according to the present invention;

FIG. 6 is also another cross sectional diagram illustrating the operating state of the disc brake pad made of multi-compounds according to the present invention;

FIG. 7 is a perspective diagram illustrating the abrasion area of the brake member being comprised of at lease one block according to a third embodiment of the present invention;

FIG. 8 is a cross sectional diagram illustrating the operating state of a disc brake pad made of multi-compounds according to a second embodiment of the present invention;

FIG. 9 is a perspective diagram illustrating the assembly of the brake member of the disc brake pad made of multi-compounds according to the second embodiment of the present invention

FIG. 10 is another cross sectional diagram illustrating the operating state of the disc brake pad made of multi-compounds according to the second embodiment of the present invention;

FIG. 11 is a perspective diagram illustrating the abrasion area of the brake member being comprised of at lease one block according to a fourth embodiment of the present invention;

FIG. 12 is a perspective diagram illustrating the abrasion area of the brake member being comprised of at lease one block according to a fifth embodiment of the present invention;

FIG. 13 is a flow chart illustrating a manufacturing process of a disc brake pad made of multi-compounds according to the present invention.

### DETAILED DESCRIPTION OF THE PREFERRED EMBODIMENT

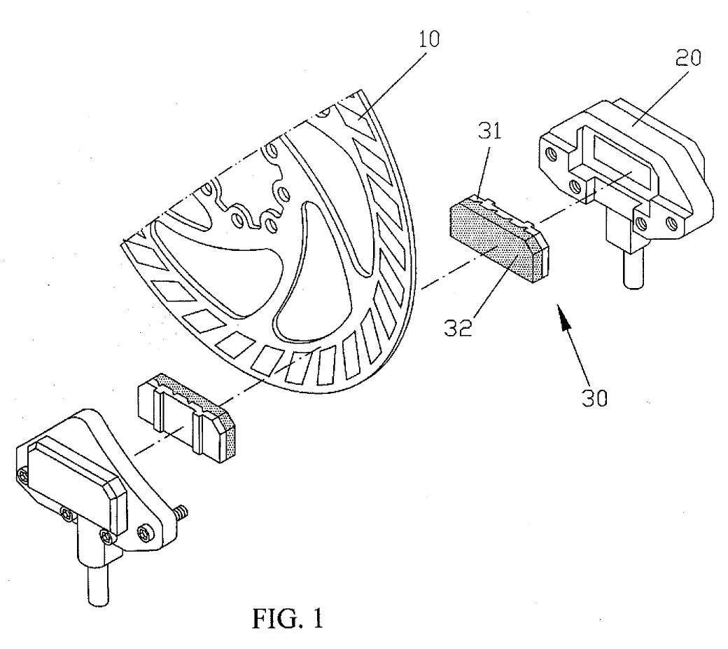

Referring to FIG. 1, a disc brake pad made of multi-compounds in accordance with a first embodiment of the present invention comprises a brake disc 10, a brake caliper 20 including a brake member 30 attached therein for clamping the brake disc 10, such that a wheel of a running bicycle may be braked.

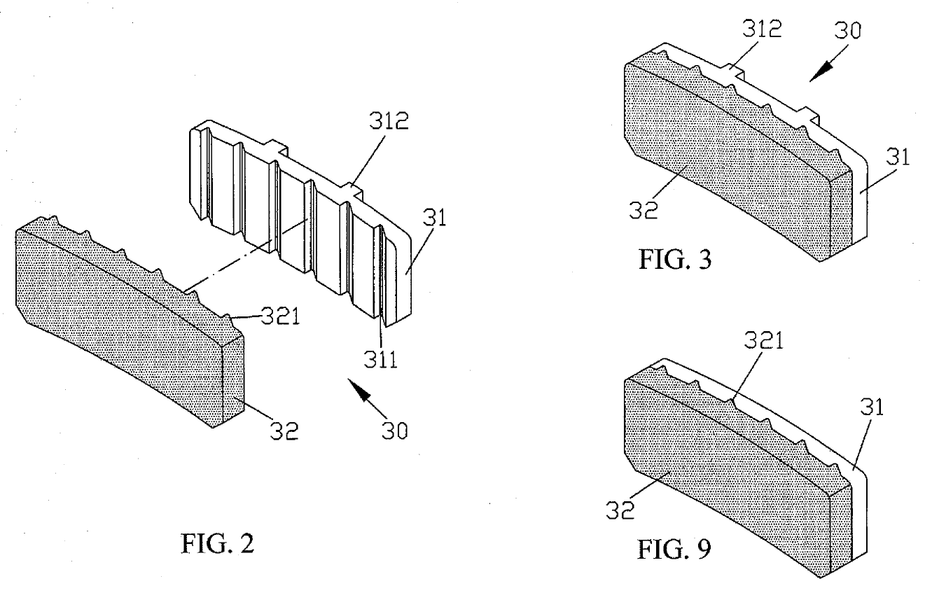

As shown in FIG. 2, the brake member 30 is formed of a body 31 and an abrasion area 32, the body 31 includes a plurality of parallel elongated slots 311 arranged on one side thereof and evenly spaced apart from each other for a tight engagement with the abrasion area 32. The abrasion area 32 includes a plurality of parallel ribs 321 relative to the elongated slots 3 11 arranged on one side thereof and equally spaced apart from each other such that the ribs 321 may be matingly received in the elongated slots 311.

As illustrated in FIGS. 3 and 9, the body 31 may be a metal material made of aluminum, steel or stainless steel and the like, and if one of the frictional compounds consists of sintered metal is copper plated to facilitate bonding to the body 31 further includes a number of protrusions 312 disposed on another side thereof and extending outwardly therefrom.

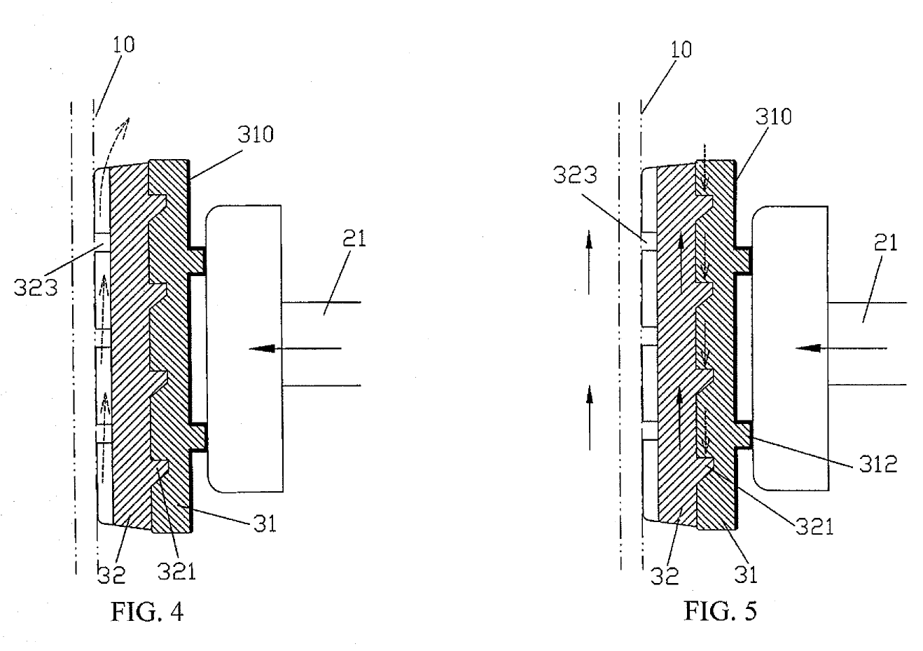

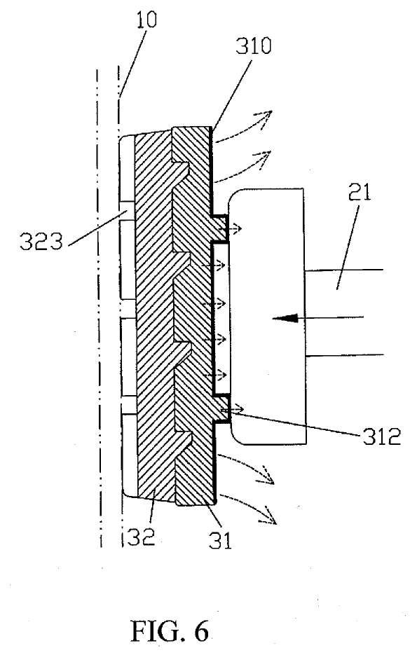

With reference to FIGS. 4-6, the body 31 includes a heat resisting layer 310 covered on at least one side thereof for lowering heat conduction, the heat resisting layer 310 may be made of ceramic materials or heat insulating materials so as to lower a heat conduction to the body 31.

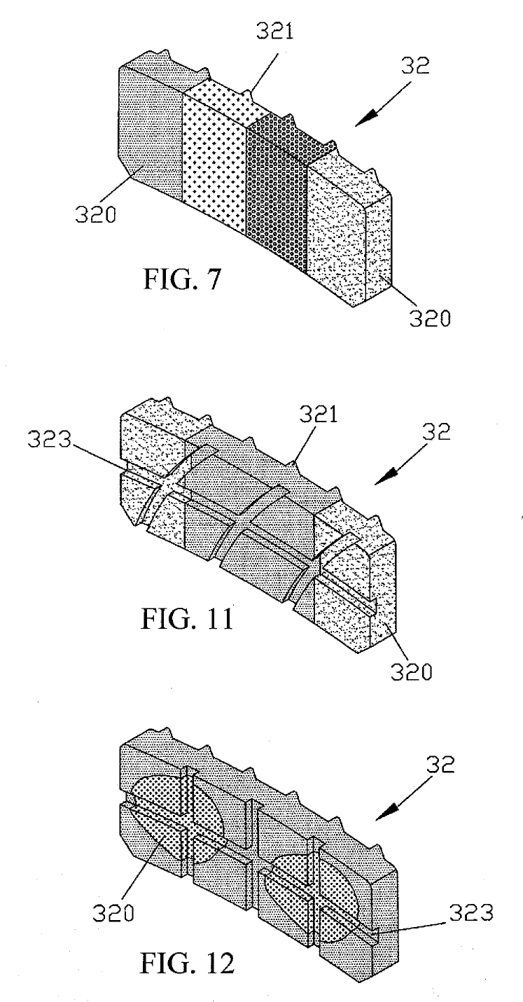

As shown in FIGS. 7, 11 and 12, the abrasion area 32 is located at one side of the body 30 and comprised of at lease one block 320 made of friction compounds, and is further spaced out a plurality of blocks 320 apart for being made of various types of friction compounds which could be further distinguished from each other by way of different colors. Furthermore, the blocks 320 may be formed of wear proof, anti slip, heat resisting, and quick-brake available and the like materials, thereby accommodating in different conditions, such as in a rainy day or on a muddy road.

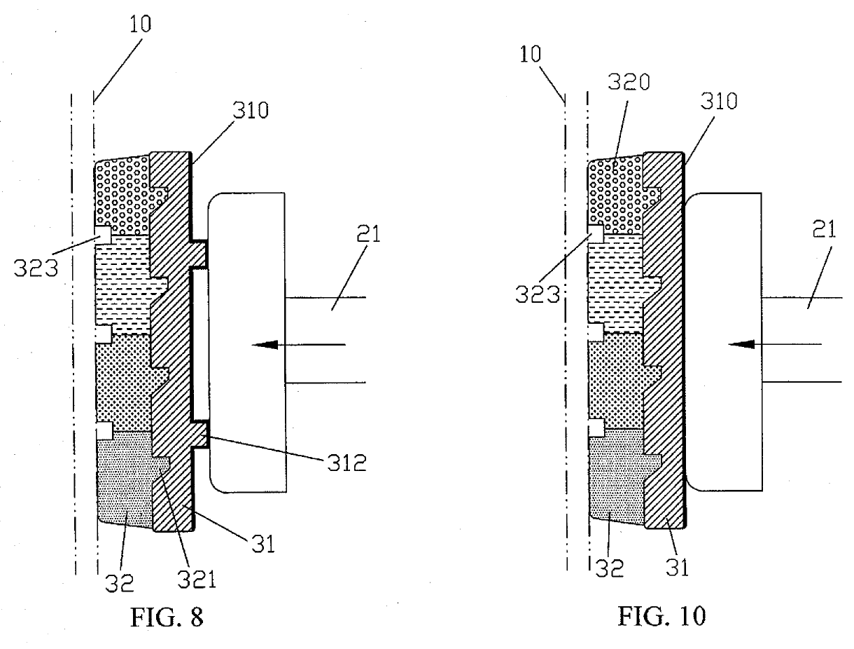

In operation, as shown in FIGS. 8 and 10, a disk brake pad made of multi-compounds in accordance with a second embodiment of the present invention may be provided to effectively reduce the heat conduction, thus enhancing the brake performance.

As illustrated in FIGS. 1-6, as desiring to stop the operating brake disc 10 of the bicycle, the user merely has to press a handle of the bicycle, and by using hydraulic pressure or cables and a mechanism pistons 21 of the brake calipers 20, the bodies 31 are pushed to displace toward the two sides of the operating brake disk 10 respectively, simultaneously stopping the operating brake disk 10.

With reference to FIG. 4, since one side of the body 31 is covered by the heat resisting layer 310 made of ceramic materials or heat insulating materials, the heat will be effectively stopped conducting to the body 31, such that the abrasion area 32 may not cause a high temperature resulting from friction to prevent the denaturalization of the brake oil, thereby maintaining the brake performance. On the other hand, on one side of the body 31 are arranged the protrusions 312, accordingly the area of the body 31 contacting with the piston 21 of the brake caliper 20 becomes smaller, thus decreasing heat conduction, these protrusions 312 would also facilitate air flow between said brake disc 10 and piston 21. Additionally the frictional compound that lest readily conducts heat could be positioned on the opposite side of the backing plate area that directly comes into contact with the piston 21 furthermore reducing heat transfer to the brake fluid.

Referring to FIGS. 4 and 5, on another side of the abrasion area 32 opposite to the ribs 321 are formed a number of intersected passages 323 for obtaining heat releasing, water discharging and pollution preventing purpose.

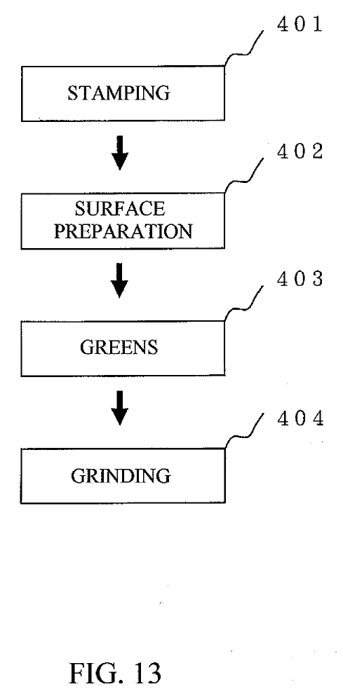

As illustrated in FIG. 13, a manufacturing process of a disc brake pad made of multi-compounds according to the present invention includes the steps of:

I. Stamping 401: Forming a body, wherein a metal plate is first formed in a stamping process, and the body 31 is made of either aluminum, steel, or stainless steel and the like metal materials.

II. Surface Preparation 402: the body 31 is can be sand blasted to achieve surface roughness suitable for bonding of cooper coating and/or provide a surface for subsequent adhesive for bonding of the frictional material, wherein
plating: the surface of the metal plate is plated to form a copper layer by using electro-plating or the like, the plating method may be replaced by a high temperature spraying method; if no sintered friction compound is required in final product this process could be omitted, wherein
adhesive application: the body 31 surface in contact with one or all the frictional compound blocks 32 is coated with an adhesive to improve the bond strength between the two. If sintered material is required in the final product this process may be omitted;

III. Greens 403: wherein any number of friction compound s are pressed to form a semi-solid composite material by using a pressing method, for certain compounds these pre-forms may also need to be manufactured at elevated temperature, and the semi-solid composite material is placed onto one side of the body 31, and then by means of a pressing machine, the body 31 is pressed with the semi-solid composite material so as to combine them tightly, forming a brake member 30, this process usually takes place at elevated temperature to improve bonding between all the different materials constituting the compound and to cure the adhesive to improve the bond between the friction compound and the body 31, wherein
hot/cold pressing: forming an abrasion area 32, wherein the individual compounds are press formed to become blocks such that the abrasion area 32 is made of different compounds each of which come into contact with the disk solely or simultaneously; the abrasion area 32 will be made up of at least two compounds consisting of either sintered metal block, semi-metallic block, or organic block. Note other frictional compounds could be considered such as ceramic or carbon, in which at lease two kinds of compounds may be selected to produce the abrasion area 32, wherein

the sintered compound block implies that it is the friction compound made of more than 60% of metal and is manufactured using a sintering process, the blended friction compounds are placed into a sintering processor, whereby a compressive load is applied to the compound whilst the temperature of which is maintained within 800-1200 degrees for 4-8 hours;

the semi-metallic block denotes that it is the friction compound made of 30%-60% of metal content and is manufactured using either hot or cold press production techniques;

the organic block means that it is the friction compound made of less than 30% of metal content and is manufactured using either hot or cold press production techniques; if necessary further curing of both the semi-metallic or organic friction compound can be carried out by placing product into a heat treater, the temperature of which is maintained within 100-250 degrees and may last around 2-8 hours, wherein
heat treating: the brake member 30 is placed into the hot treater for heating, thereby enhancing its hardness and toughness. If necessary the brake pad may be further coated using a spray painting method for example to improve corrosion resistance and/or to improve aesthetics.

IV. Grinding 404, wherein the surface of the brake member 30 is ground by a grinding machine so as to eliminate impurities attached thereon and to achieve required section thickness.

It can be clearly seen from the preceding accounts on the features of the present invention that the disc brake pad made of multi-materials of the present invention has the following advantages:
1. Enhancing the brake performance: the present invention is manufactured by using a composite forming method, thereby enabling to combine various kinds of frictional compounds together, thereby improving braking performance over a wider range different conditions.
2. Improving heat conduction: the present invention is manufactured by adding the heat resisting compound directly over piston contact area therein and by using a heat resisting method, prohibiting the heat generated due to friction at the brake/disk interface from transferring to the brake fluid, and increasing the stability of brake.
3. Improving heat conduction: the present invention is manufactured by adding the heat resisting layer to the backing plate therein and by using a heat resisting method, prohibiting the heat generated due to friction at the brake/disk interface from transferring to the brake fluid, and increasing the stability of brake.
4. Improving heat conduction: the present invention is manufactured by adding on one side of the body 31 protrusions 312, accordingly the area of the body 31 contacting with the piston 21 of the brake caliper 20 becomes smaller, thus decreasing heat conduction.

The invention is not limited to the above embodiment but various modifications thereof may be made. It will be understood by those skilled in the art that various changes in form and detail may be made without departing from the scope and spirit of the present invention.

What is claimed is:

1. A manufacturing process of a disc brake pad made of multi-compounds comprising the steps of:
I. Stamping: forming a body, wherein a metal plate is first formed in a stamping process;
II. Surface Preparation: the body can be sand blasted to achieve surface roughness suitable for bonding of cooper coating;
III. Greens: any number of friction compounds are pressed to form a semi-solid composite material by using a pressing method, wherein
the sinter greens, wherein the surface of the metal plate is plated to form a copper layer by using electroplating or the like, the blended friction compounds are placed into a sintering processor;
the semi-metallic layer denotes that it is the friction compound made of 30%-60% of metal content and is manufactured using either hot or cold press production techniques;
the organic greens, wherein the body's surface in contact with one or all the frictional compound blocks is coated with an adhesive, the organic layer means that it is the friction compound made of less than 30% of metal content and is manufactured using either hot or cold press production techniques;
IV. Grinding: wherein the surface of the brake member is ground by a grinding machine so as to eliminate impurities attached thereon and to achieve required section thickness.

2. The manufacturing process of a disc brake pad made of multi-compounds as claimed in claim 1, wherein said body is made of aluminum, steel, or stainless steel and the like metal materials.

3. The manufacturing process of a disc brake pad made of multi-compounds as claimed in claim 1, wherein said plating method may be replaced by a high temperature spraying method.

4. The manufacturing process of a disc brake pad made of multi-compounds as claimed in claim 1, wherein in the sintering process, the frictional materials are placed into a sintering processor, the temperature of which is maintained within 800-1200 degrees and is lasted for 4-8 hours.

5. The manufacturing process of a disc brake pad made of multi-compounds as claimed in claim 1, wherein the frictional material is curing of both the semi-metallic or organic friction compound and placed into a heat theater, the temperature of which is maintained within 100-250 degrees and is lasted around 2-8 hours.

6. A disc brake pad being characterized in that it is manufactured by using said manufacturing process as claimed in claim 1.

7. A manufacturing process of a disc brake pad made of multi-compounds comprising a brake member formed of a body and an abrasion area, said body being constructed in the formed of an elongated plate, wherein said abrasion area is located at one side of said body and comprised of blocks made of different compounds, at least including a sinter block, semi-metallic, or an organic block in which at lease two kinds of compound may be selected to produce said abrasion area.

8. A disc brake pad for use in a bicycle comprising:
a brake disc;
a brake caliper including a brake member attached therein for clamping said brake disk and formed of a body and an abrasion area, said body being constructed in the form of an elongated plate by using a stamping method;
an abrasion area located at one side of said body and comprised of at least two blocks made of different frictional compounds.

9. The disc brake pad for use in a bicycle as claimed in claim 8, wherein said body includes a plurality of parallel elongated slots arranged on one side thereof and evenly spaced apart from each other for a tight engagement with said abrasion area; said abrasion area includes a plurality of parallel ribs relative to said elongated slots arranged on one side thereof and equally spaced apart from each other such that said ribs may be matingly received in said elongated slots.

10. The disc brake pad for use in a bicycle as claimed in claim 8, wherein said body is made of aluminum, steel, or stainless steel and the like metal materials.

11. The disc brake pad for use in a bicycle as claimed in claim 8, wherein said body further includes a number of protrusions disposed on another side thereof and extending outwardly therefrom.

12. The disc brake pad for use in a bicycle as claimed in claim 8, wherein said body includes a heat resisting layer covered on at least one side thereof for lowering heat conduction.

13. The disc brake pad for use in a bicycle as claimed in claim 11, wherein said heat resisting layer may be made of ceramic materials or heat insulating materials so as to lower heat conduction to said body.

14. The disc brake pad for use in a bicycle as claimed in claim 8, wherein said abrasion area is further spaced out a plurality of blocks apart for being made of various types of abrasion materials.

15. The disc brake pad for use in a bicycle as claimed in claim 13, wherein the frictional materials of said abrasion area are distinguished from each other by way of different colors.
